(19) United States
(12) Patent Application Publication
(10) Pub. No.: US 2025/0300384 A1
(43) Pub. Date: Sep. 25, 2025

(54) ELECTRICAL CONNECTOR, ELECTRICAL CONNECTOR ASSEMBLY AND TERMINAL MODULE

(71) Applicant: Molex, LLC, Lisle, IL (US)

(72) Inventors: Weng-Heng Liong, Jurong Town (SG); Po-Wen Chen, New Taipei City (TW)

(21) Appl. No.: 19/082,237

(22) Filed: Mar. 18, 2025

(30) Foreign Application Priority Data
Mar. 20, 2024 (CN) 202410319451.5

(51) Int. Cl. H01R 13/405; H01R 13/04; H01R 13/6471

(52) U.S. Cl. CPC H01R 13/405; H01R 13/04; H01R 13/6471

(57) ABSTRACT

A terminal module includes a differential signal terminal pair, two ground terminals and an insulative bracket. Each ground terminal has a plate surface. The insulative bracket is integrally molded to locally clad the differential signal terminal pair and the two ground terminals. The insulative bracket has a surface which corresponds to the plate surfaces of the two ground terminals, the surface is provided with two depressed segments. At least a part of a position of each depressed segment corresponds to the plate surface of the corresponding ground terminal, each depressed segment is an elongated structure and a length direction of each depressed segment extends along a length direction of the corresponding ground terminal. As such, good signal integrity efficacy can be maintained when a signal is transmitted by the two signal terminals, so that crosstalk between the two adjacent differential signal terminal pairs can be lowered.

### TECHNICAL FIELD

The present disclosure relates to an electrical connector, and particularly relates to an electrical connector, an electrical connector assembly and a terminal module for high speed transmission of signals.

### BACKGROUND

Digital data transmission often uses an electrical connector as an interface of transmission, speed and quality of signal transmission of the electrical connector will influence speed and stability of data transmission. Because an amount of data to be transmitted is increasing and speed of signal transmission is getting faster and faster, how to maintain good signal integrity (SI) efficacy in signal transmission at high speed becomes an important subject.

### SUMMARY

Therefore, one of objects of the present disclosure is to provide a terminal module which can overcome at least one deficiency in the prior art.

Accordingly, a terminal module of the present disclosure comprises a differential signal terminal pair, two ground terminals and an insulative bracket. The two ground terminals are respectively positioned to outer sides of the differential signal terminal pair. Each ground terminal has a plate surface. The insulative bracket is integrally molded to locally clad the differential signal terminal pair and the two ground terminals, the insulative bracket has a surface which corresponds to the plate surfaces of the two ground terminals, the surface is provided with two depressed segments. At least a part of a position of each depressed segment corresponds to the plate surface of the corresponding ground terminal, each depressed segment is an elongated structure and a length direction of each depressed segment extends along a length direction of the corresponding ground terminal.

In some embodiments, the insulative bracket further has a bottom surface which is connected to the surface and a top surface which is connected to the surface and is opposite to the bottom surface, each depressed segment at least extends to one of the bottom surface and the top surface.

In some embodiments, each depressed segment extends to the bottom surface and the top surface.

In some embodiments, the insulative bracket further has a bottom surface which is connected to the surface and a top surface which is connected to the surface and is opposite to the bottom surface, each depressed segment is spaced apart from the bottom surface and the top surface.

In some embodiments, each depressed segment is formed with a depressed hole.

In some embodiments, the depressed hole is a through hole which allows the plate surface of the corresponding ground terminal to be locally exposed.

In some embodiments, the depressed hole is a blind hole which does not allow the plate surface of the corresponding ground terminal to exposed.

In some embodiments, the depressed hole has an elongated hole shape and a length direction of the depressed hole extends along the length direction of the corresponding ground terminal, the depressed hole has a length taken along the length direction of the corresponding ground terminal, a width taken along a width direction of the corresponding ground terminal, and a depth taken along a depth direction which is perpendicular to the length direction and the width direction.

In some embodiments, each depressed segment is formed with a first depressed hole and a second depressed hole which are arranged along the length direction of the corresponding ground terminal and are communicated with each other, the first depressed hole is a through hole which allows the plate surface of the corresponding ground terminal to be locally exposed, the second depressed hole is a blind hole which does not allow the plate surface of the corresponding ground terminal to exposed.

In some embodiments, each depressed segment has two inner side surfaces and at least one bridging portion which is connected between the two inner side surfaces, each depressed segment is formed with at least one first depressed hole which is positioned between the two inner side surfaces and is positioned to an end of the bridging portion.

In some embodiments, each depressed segment is formed with the two first depressed holes which are respectively positioned to two opposite ends of the bridging portion and are arranged along the length direction of the corresponding ground terminal.

In some embodiments, the bridging portion and the surface are spaced apart from each other each other, each depressed segment is further formed with a second depressed hole which is positioned between the two inner side surfaces and the bridging portion, the first depressed hole is a through hole which allows the plate surface of the corresponding ground terminal to be locally exposed, the second depressed hole is a blind hole which is communicated with the first depressed hole and does not allow the plate surface of the corresponding ground terminal to be exposed.

In some embodiments, each depressed segment has a plurality of bridging portions which are arranged to be spaced apart from each other along the length direction of the corresponding ground terminal, each depressed segment is formed with a plurality of first depressed holes, each first depressed hole is positioned between the two adjacent bridging portions.

In some embodiments, each bridging portion and the surface are spaced apart from each other, each depressed segment is further formed with a plurality of second depressed holes, each first depressed hole is a through hole which allows the plate surface of the corresponding ground terminal to be locally exposed, each second depressed hole is positioned between the two inner side surfaces and the corresponding bridging portion, each second depressed hole is a blind hole which is communicated with the corresponding first depressed hole and does not allow the plate surface of the corresponding ground terminal to be exposed.

In some embodiments, the insulative bracket further has a bottom surface which is connected to the surface and a top surface which is connected to the surface and is opposite to the bottom surface, two of the plurality of second depressed holes of each depressed segment which are the most away from each other extend to the bottom surface and the top surface respectively.

In some embodiments, each depressed segment has an inner periphery surface which is in form of encircled and closed shape, each depressed segment is formed with a depressed hole which is positioned in the inner periphery surface.

In some embodiments, the depressed hole is a through hole which allows the plate surface of the corresponding ground terminal to be locally exposed.

One of objects of the present disclosure is to provide an electrical connector which can overcome at least one deficiency in the prior art.

Accordingly, an electrical connector of the present disclosure comprises an insulative housing and the aforementioned terminal modules. The insulative housing has multiple side walls which are spaced apart from each other, every two adjacent side walls of the insulative housing being therebetween formed with a plurality of receiving cavities. The terminal modules are provided to the insulative housing, each terminal module is mounted to the corresponding receiving cavity.

In some embodiments, one of the multiple side walls corresponding to each receiving cavity is provided with at least one first retaining portion, the insulative bracket has at least one second retaining portion which is retained to the first retaining portion.

In some embodiments, the first retaining portion is a protruding rib, the second retaining portion is a recessed groove which snaps with the first retaining portion.

In some embodiments, one of the multiple side walls corresponding to each receiving cavity is provided with the two first retaining portions, the insulative bracket has the two second retaining portions which respectively retain the two first retaining portions.

In some embodiments, the two second retaining portions are respectively positioned to two opposite sides of the insulative bracket, each second retaining portion corresponds to the corresponding ground terminal.

In some embodiments, the insulative bracket further has two outer side surfaces which respectively face the two second retaining portions and two retaining protrusions which respectively protrude from the two outer side surfaces, each retaining protrusion interferes with the corresponding first retaining portion.

In some embodiments, the differential signal terminal pair has two signal terminals, each second retaining portion is correspondingly positioned between the corresponding signal terminal and the corresponding ground terminal.

In some embodiments, the insulative bracket has two inner side surfaces which are positioned to two opposite sides of the corresponding second retaining portion, and a retaining protrusion which protrudes from at least one of the two inner side surfaces, the retaining protrusion interferes with the corresponding first retaining portion.

In some embodiments, the insulative bracket of each terminal module further has an end surface which faces the side wall provided with the first retaining portion and a protruding portion which protrudes from the end surface, the protruding portion interferes with the side wall which is provided with the first retaining portion.

In some embodiments, the insulative housing further has a plurality of partitioning plates which are provided between every two adjacent side walls, every two adjacent side walls and the plurality of partitioning plates of the insulative housing cooperate with each other to form the plurality of the receiving cavities.

In some embodiments, the differential signal terminal pair has two signal terminals, the insulative housing has a mounting portion and a mating portion which are positioned to two opposite sides of the insulative housing, the plurality of the receiving cavities are formed to the mounting portion, the mating portion of the insulative housing is formed with a plurality of inserting grooves, the side wall corresponding to each inserting groove is provided with a plurality of protruding blocks, each protruding block corresponds to the two signal terminals of the corresponding differential signal terminal pair.

One of objects of the present disclosure is to provide an electrical connector assembly which can overcome at least one deficiency in the prior art.

Accordingly, an electrical connector assembly of the present disclosure comprises a first electrical connector and a second electrical connector. The first electrical connector comprises an insulative housing and the aforementioned terminal modules. The insulative housing has a side wall. The terminal modules are staggeringly provided to two sides of the side wall. The second electrical connector mates with the first electrical connector and comprises an insulative housing and the aforementioned terminal modules. The insulative housing is formed with an inserting groove which allows the side wall to insert therein. The terminal modules are staggeringly provided to two sides of the inserting groove.

In some embodiments, the differential signal terminal pair of the first connector and the differential signal terminal pair of the second electrical connector each have two signal terminals, each terminal of the first electrical connector has an elastic contact portion and a tail portion which are exposed to the insulative bracket, the elastic contact portions of the terminals of the two corresponding terminal modules which are respectively provided to the two sides of the side wall are reversely provided and bend and extend respectively toward a direction close to the side wall, the tail portions of the terminals of the two corresponding terminal modules which are respectively provided to the two sides of the side wall bend and extend toward the same direction, each terminal of the second electrical connector has an elastic contact portion and a tail portion which are exposed to the insulative bracket, the elastic contact portions of the terminals of the two corresponding terminal modules which are respectively provided to the two sides of the inserting groove are reversely provided and bend and extend respectively toward a direction away from the inserting groove, are used to mate with the terminals of the two corresponding terminal modules which are respectively provided to the two sides of the side wall, the tail portions of the terminals of the two corresponding terminal modules which are respectively provided to the two sides of the inserting groove bend and extend toward the same direction.

One of objects of the present disclosure is to provide a terminal module which can overcome at least one deficiency in the prior art.

Accordingly, a terminal module of the present disclosure comprises an insulative bracket, a differential signal terminal pair, a first ground terminal and a second ground terminal. The insulative bracket has a surface. The differential signal terminal pair is fixed to the insulative bracket, the differential signal terminal pair has a first signal terminal and a second signal terminal, each signal terminal has a body portion, an elastic contact portion which extends from a first end of the body portion, and a tail portion which extends from a second end of the body portion, the surface covers at least most of the body portion of the first signal terminal and at least most of the body portion of the second signal terminal. The first ground terminal and the second ground terminal are fixed to the insulative bracket, the first ground terminal is adjacent to the first signal terminal, the second ground terminal is adjacent to the second signal terminal, each ground terminal has a body portion, an elastic contact portion which extends from a first end of the body portion, and a tail portion which extends from a second end of the body portion, the surface covers at least a part of the body portion of the first ground terminal and at least a part of the body portion of the second ground terminal, the surface is provided with at least one first depressed segment, the first depressed segment exposes a part of the body portion of the first ground terminal, the surface is provided with at least one second depressed segment, the second depressed segment exposes a part of the body portion of the second ground terminal.

In some embodiments, the first depressed segment exposes most of the body portion of the first ground terminal, the second depressed segment exposes most of the body portion of the second ground terminal.

In some embodiments, the surface further provided with at least one third depressed segment which is positioned to a side of the first depressed segment and at least one fourth depressed segment which is positioned to a side of the second depressed segment, a depressed depth of the third depressed segment is less than a depressed depth of the first depressed segment, a depressed depth of the fourth depressed segment is less than a depressed depth o the second depressed segment.

In some embodiments, the surface is provided with the two third depressed segments which are respectively positioned to two opposite sides of the first depressed segment and two fourth depressed segments which are respectively positioned to two opposite sides of the second depressed segment.

In some embodiments, the surface is provided with two first depressed segments and two second depressed segments.

In some embodiments, the surface is further provided with at least one third depressed segment which is positioned to a side of the corresponding first depressed segment and at least one fourth depressed segment which is positioned to a side of the corresponding second depressed segment, a depressed depth of the third depressed segment is less than a depressed depth of the first depressed segment, a depressed depth of the fourth depressed segment is less than a depressed depth of the second depressed segment.

In some embodiments, the third depressed segment is positioned between the two first depressed segments, the fourth depressed segment is positioned between the two second depressed segments.

In some embodiments, the first depressed segment and the third depressed segment are arranged along a length direction of the first ground terminal, the second depressed segment and the fourth depressed segment are arranged along a length direction of the second ground terminal.

The present disclosure at least has the following effects: by the design manner that each terminal module has the two depressed segments which are depressed to the surface, at least a part of a position of each depressed segment corresponds to the corresponding ground terminal, and each depressed segment is an elongated structure and a length direction of each depressed segment extends along the length direction of the corresponding ground terminal, coupling between each ground terminal and the adjacent corresponding signal terminal can be lowered, so as to promote coupling between the two signal terminals of the differential signal terminal pair, good signal integrity efficacy can be maintained when a signal is transmitted by the two signal terminals, so that crosstalk between the two adjacent differential signal terminal pairs can be lowered.

### BRIEF DESCRIPTION OF THE DRAWINGS

Other features and effects of the present disclosure will be apparent from embodiments with reference to the drawings, in which:

FIG. 1 is a perspective view of a first embodiment of an electrical connector assembly of the present disclosure illustrating that two electrical connectors mate with each other;

FIG. 2 is a perspective exploded view of the first embodiment illustrating an assembling relationship between the two electrical connectors;

FIG. 3 is an incomplete perspective exploded view of the electrical connector of the first embodiment illustrating an assembling relationship between an insulative housing and a plurality of terminal rows;

FIG. 4 is an incomplete top view of the electrical connector of the first embodiment;

FIG. 5 is an incomplete bottom view of the electrical connector of the first embodiment;

FIG. 6 is an incomplete cross sectional view taken along a line VI-VI of FIG. 4;

FIG. 7 is an incomplete cross sectional view of the electrical connector of the first embodiment illustrating that a terminal module is mounted to a receiving cavity of the insulative housing;

FIG. 8 is an incomplete cross sectional exploded view of the electrical connector of the first embodiment illustrating an assembling relationship between the terminal module and the receiving cavity of the insulative housing;

FIG. 9 is an incomplete perspective view of the terminal module of the first embodiment illustrating a structure of a differential signal terminal pair and two ground terminals with an insulative bracket omitted;

FIG. 10 is a side view of the terminal module of the first embodiment;

FIG. 11 is a perspective view of the terminal module of the first embodiment viewed from another angle;

FIG. 12 is a side view of the terminal module of the first embodiment;

FIG. 13 is a cross sectional view taken along a line XIII-XIII of FIG. 12;

FIG. 14 is an incomplete cross sectional view of the first embodiment;

FIG. 15 is an incomplete cross sectional view of an electrical connector of a second embodiment of the electrical connector assembly of the present disclosure;

FIG. 16 is an incomplete cross sectional exploded view of the electrical connector of the second embodiment;

FIG. 17 is a perspective view of the terminal module of the second embodiment viewed from another angle;

FIG. 18 is a side view of the terminal module of the second embodiment; and

FIG. 19 is a cross sectional view along a line XIX-XIX of FIG. 18.

### DETAILED DESCRIPTION

Before the present disclosure is described in detail, it is noted that the similar elements are indicated by the same reference numerals in the following described content.

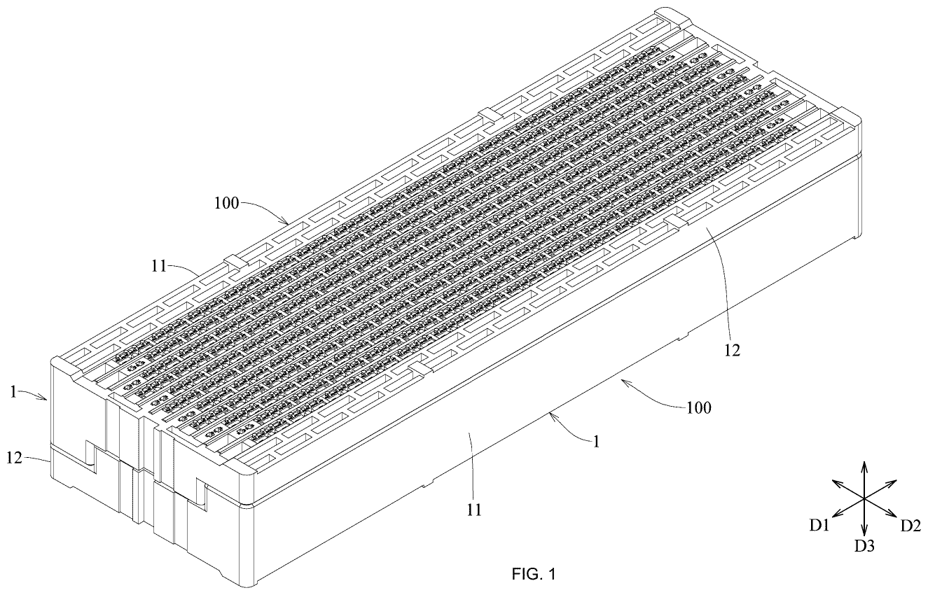

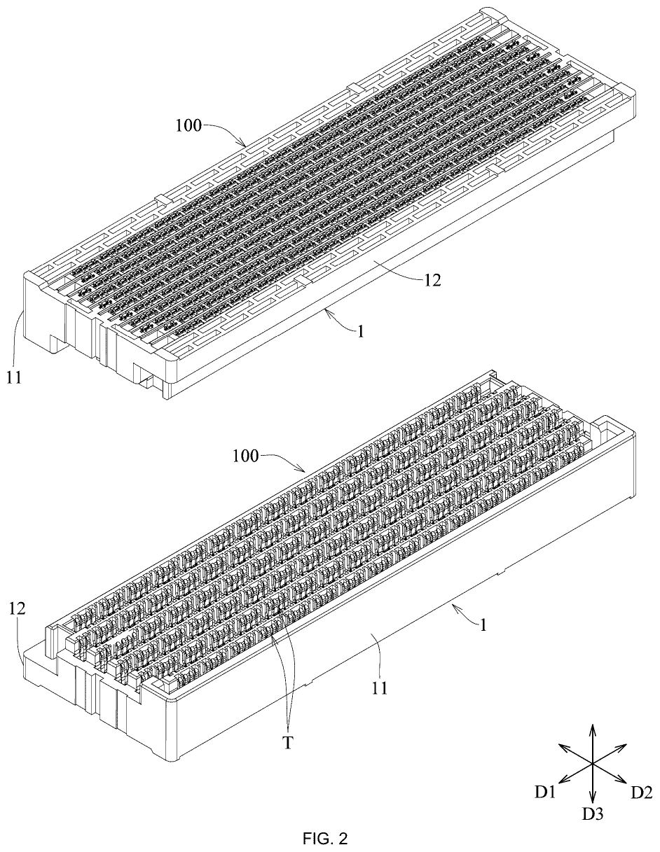

Referring to FIG. 1 and FIG. 2, a first embodiment of an electrical connector assembly of the present disclosure includes two electrical connectors 100 which have the same construction and mate with each other, the two electrical connectors 100 are Mezzanine electrical connectors. The two electrical connectors 100 may be divided into a first electrical connector and a second electrical connector which mates with the first electrical connector.

For sake of convenience of later description, in the electrical connector assembly, a first direction D1, a second direction D2 perpendicular to the first direction D1 and a third direction D3 perpendicular to the first direction D1 and the second direction D2 are defined. The first direction D1 is one of a front-rear direction and a left-right direction. The second direction D2 is the other of the front-rear direction and the left-right direction. The third direction D3 is an up-down direction.

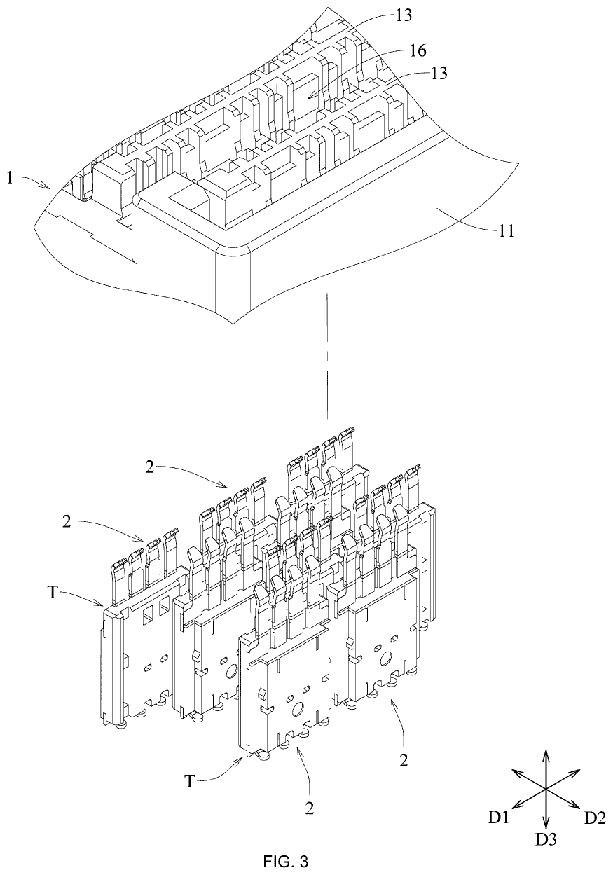

Referring to FIG. 3 to FIG. 8, each electrical connector 100 includes an insulative housing 1 and a plurality of terminal rows T provided to the insulative housing 1. The insulative housing 1 has a first side 11, a second side 12, a plurality of first side walls 13 and a plurality of second side walls 14. The first side 11 and the second side 12 are parallel to the first direction D1 and are respectively positioned to two opposite sides of the insulative housing 1. The plurality of first side walls 13 are spaced apart each other from along the second direction D2 and are interposed between the first side 11 and the second side 12. The plurality of second side walls 14 are spaced apart from each other along the second direction D2 and are interposed between the first side 11 and the second side 12. The plurality of second side walls 14 and the plurality of first side walls 13 are arranged alternately along the second direction D2. A height of each second side wall 14 taken along the third direction D3 is less than a height of each first side wall 13 taken along the third direction D3. The insulative housing 1 further has a plurality of partitioning plates 15 provided between every two adjacent first side wall 13 and second side wall 14, the plurality of partitioning plates 15 are arranged to be spaced apart from each other along the first direction D1.

The insulative housing 1 is formed with a plurality of inserting grooves 16, the plurality of inserting grooves 16 and the plurality of first side walls 13 are arranged alternately along the second direction D2. Each inserting groove 16 is used to allow the corresponding first side wall 13 of the other electrical connector 100 to insert therein. Every two adjacent first side wall 13 and second side wall 14 and the plurality of partitioning plates 15 of the insulative housing 1 cooperate with each other to form a plurality of receiving cavities 17. The receiving cavities 17 of the insulative housing 1 are arranged as a plurality of rows R, the plurality of rows R are arranged to be spaced apart from each other along the second direction D2. The plurality of receiving cavities 17 of each row R are arranged to be spaced apart from each other along the first direction D1 and are communicated with the corresponding inserting grooves 16. Every two adjacent receiving cavities 17 along the first direction D1 are partitioned by the corresponding partitioning plate 15, so that the plurality of receiving cavities 17 and the plurality of partitioning plates 15 are arranged alternately along the first direction D1. The second side wall 14 corresponding to each receiving cavity 17 is provided with at least one first retaining portion 18. The corresponding receiving cavities 17 of every two adjacent rows R are staggeringly formed to the insulative housing 1.

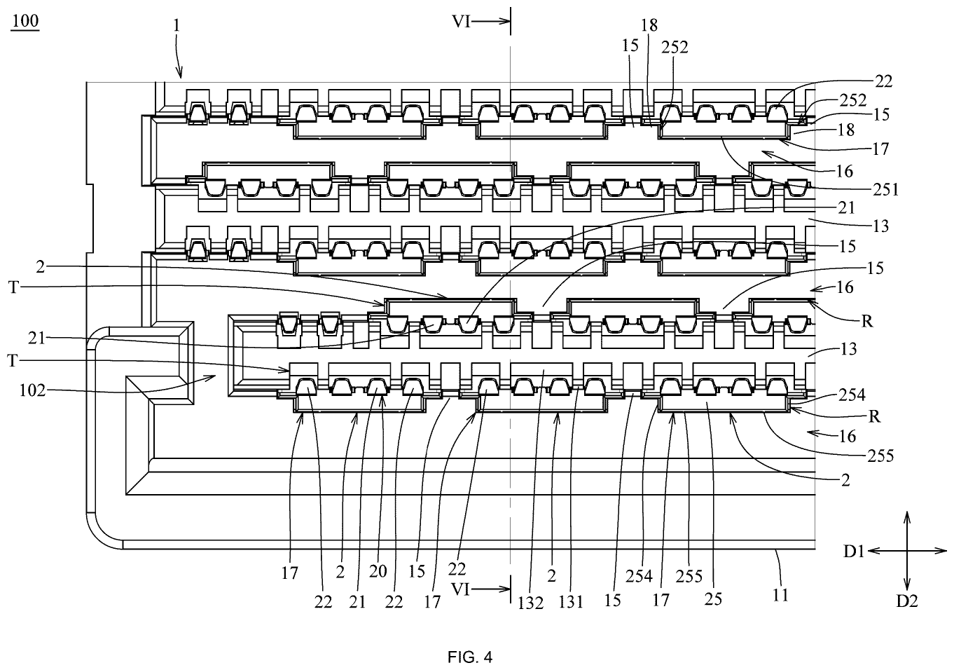

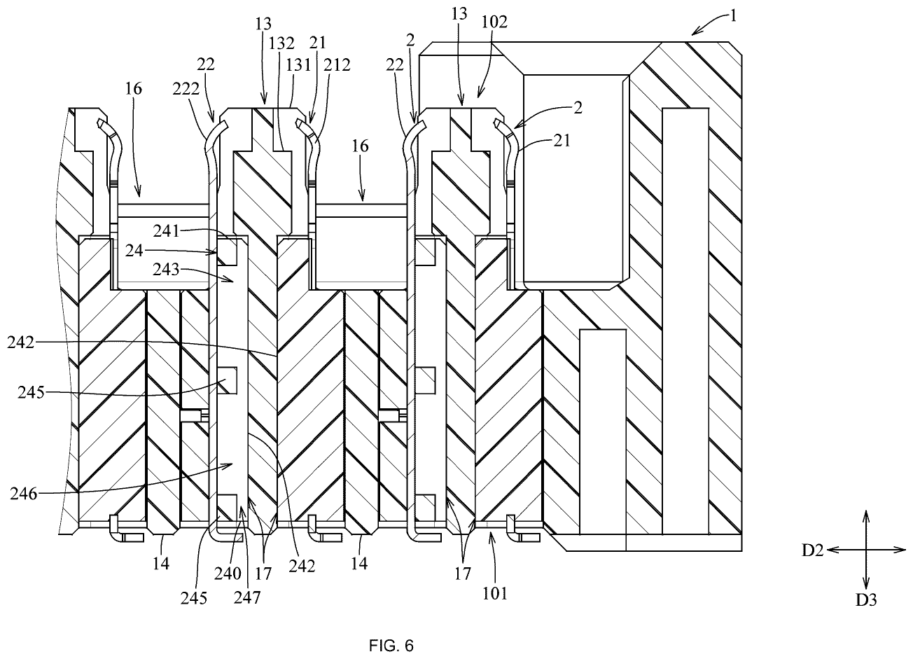

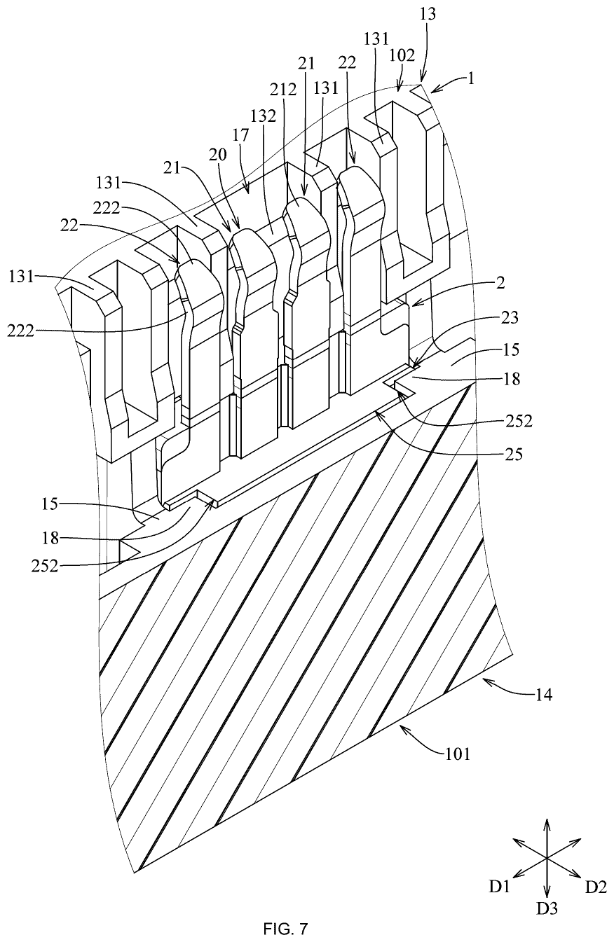

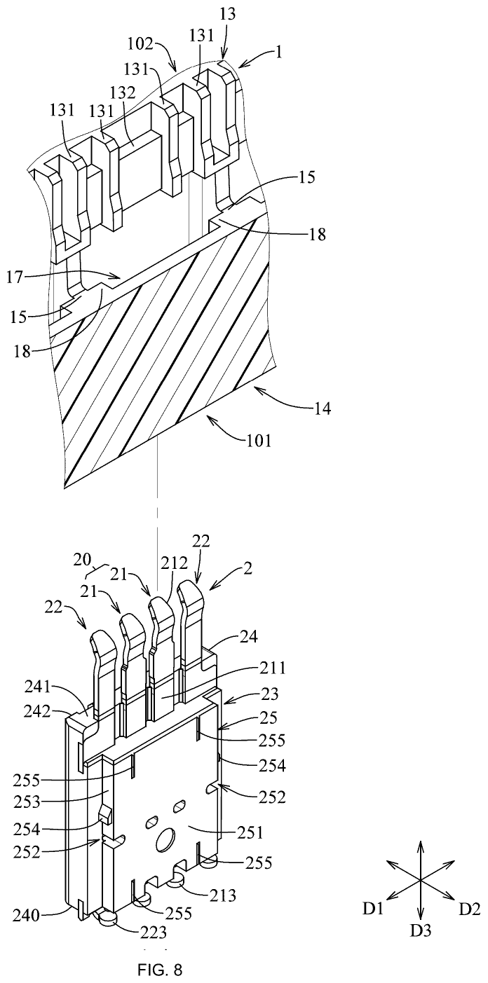

Referring to FIG. 4, FIG. 6, FIG. 7 to FIG. 8, the insulative housing 1 has a mounting portion 101 and a mating portion 102 which are positioned to two opposite sides of the insulative housing 1. The receiving cavities 17 are formed to the mounting portion 101. The mating portion 102 is formed with the plurality of inserting grooves 16. The first side wall 13 corresponding to each inserting groove 16 is provided with a plurality of partitioning ribs 131 and a plurality of protruding blocks 132.

Referring to FIG. 4 to FIG. 8, the plurality of terminal rows T are arranged to be spaced apart from each other along the second direction D2. Each terminal row T includes a plurality of terminal modules 2 which are arranged to be spaced apart from each other along the first direction D1. Each terminal module 2 is used to be mounted to the corresponding receiving cavity 17 of the insulative housing 1. The corresponding terminal modules 2 mounted to the corresponding receiving cavities 17 of every two adjacent rows R are staggeringly provided to the insulative housing 1. Each terminal module 2 includes a differential signal terminal pair 20, two ground terminals 22 which are respectively positioned to outer sides of the differential signal terminal pair 20, and an insulative bracket 23 which is integrally molded to locally clad the differential signal terminal pair 20 and the two ground terminals 22. The differential signal terminal pair 20 includes two signal terminals 21 which are arranged to be spaced apart from each other along the first direction D1. Each protruding block 132 of the insulative housing 1 corresponds to the two signal terminals 21 of the corresponding differential signal terminal pair 20.

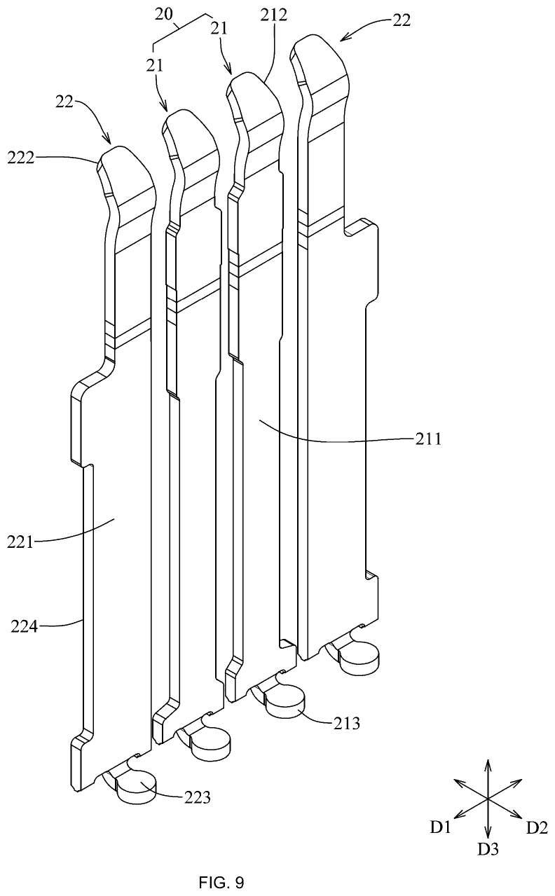

Referring to FIG. 8 to FIG. 10, each signal terminal 21 has a body portion 211, an elastic contact portion 212 which extends from an end of the body portion 211, and a tail portion 213 which extends from an end of the body portion 211 opposite to the elastic contact portion 212. Specifically, the elastic contact portion 212 extends upwardly from a top end of the body portion 211, the tail portion 213 bends downwardly from a bottom end of the body portion 211 at a right angle and extends. A bottom end of the tail portion 213 is used to allow a solder ball (not shown) to be soldered.

The two ground terminals 22 are respectively positioned to outer sides of the two signal terminals 21. Each ground terminal 22 has a body portion 221, an elastic contact portion 222 which extends from an end of the body portion 221, and a tail portion 223 which extends from an end of the body portion 221 opposite to the elastic contact portion 222. Specifically, the elastic contact portion 222 extends upwardly from a top end of the body portion 221, the tail portion 223 bends downwardly from a bottom end of the body portion 221 at a right angle and extends. A bottom end of the tail portion 223 is used to allow a solder ball (not shown) to be soldered. The body portion 221 of each ground terminal 22 has a plate surface 224.

The insulative bracket 23 is received in the corresponding receiving cavity 17. In the first embodiment, the insulative bracket 23 is to use a plastic with an integral molding manner for example insert molding to clad a part of the body portion 211 of each signal terminal 21 and a part of the body portion 221 of each ground terminal 22 to make the elastic contact portion 212 and the tail portion 213 of each signal terminal 21 respectively extend out of an upper end and a lower end of the insulative bracket 23, and make the elastic contact portion 222 and the tail portion 223 of each ground terminal 22 respectively extend out of the upper end and the lower end of the insulative bracket 23.

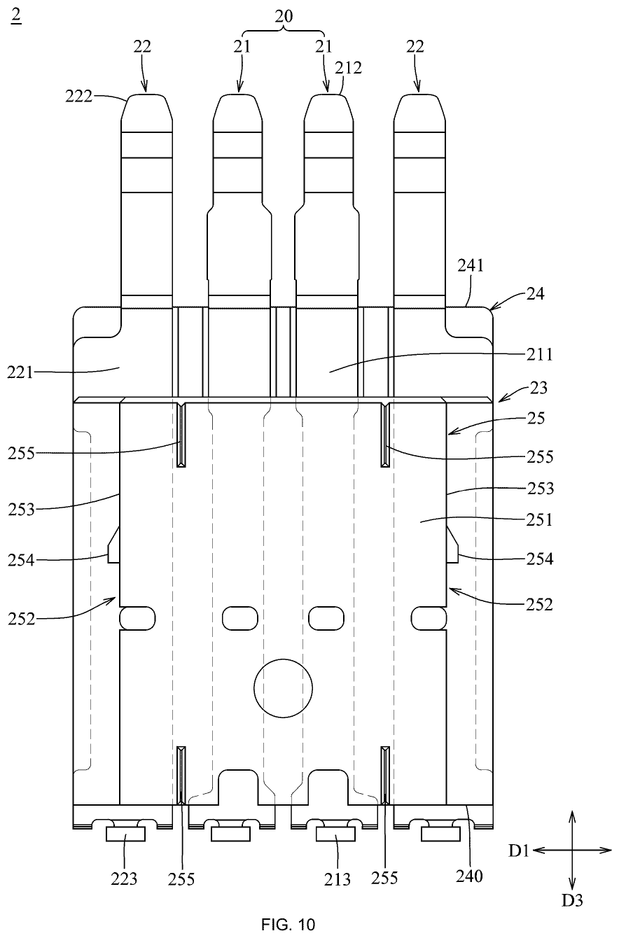

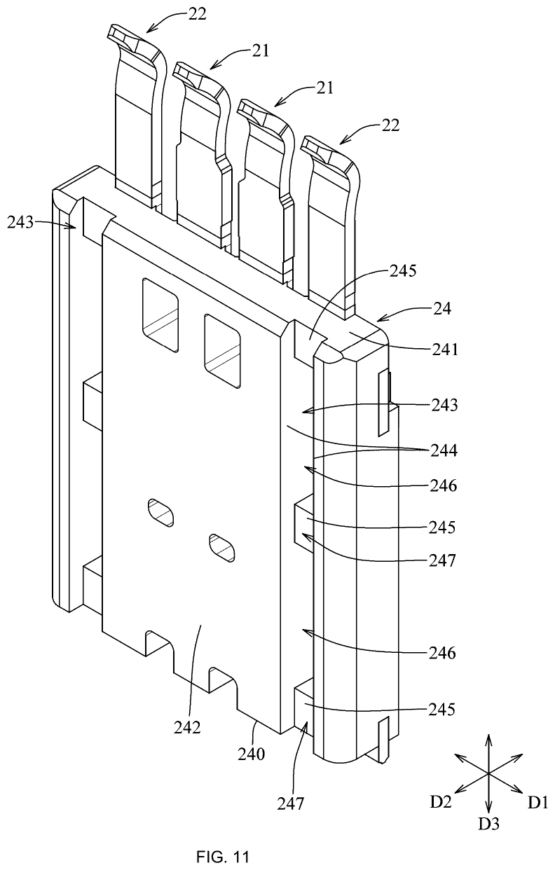

Referring to FIG. 6, FIG. 8, FIG. 10 and FIG. 11, the insulative bracket 23 has a supporting bracket body 24 and a retaining bracket body 25 which is formed to a side of the supporting bracket body 24. A height of the supporting bracket body 24 taken along the third direction D3 is more than a height of the retaining bracket body 25 taken along the third direction D3. The supporting bracket body 24 is used to support the body portion 211 of each signal terminal 21 and the body portion 221 of each ground terminal 22. The supporting bracket body 24 has a bottom surface 240, a top surface 241 which is opposite to the bottom surface 240, and a surface 242 which is connected between the bottom surface 240 and the top surface 241. The surface 242 faces the corresponding first side wall 13.

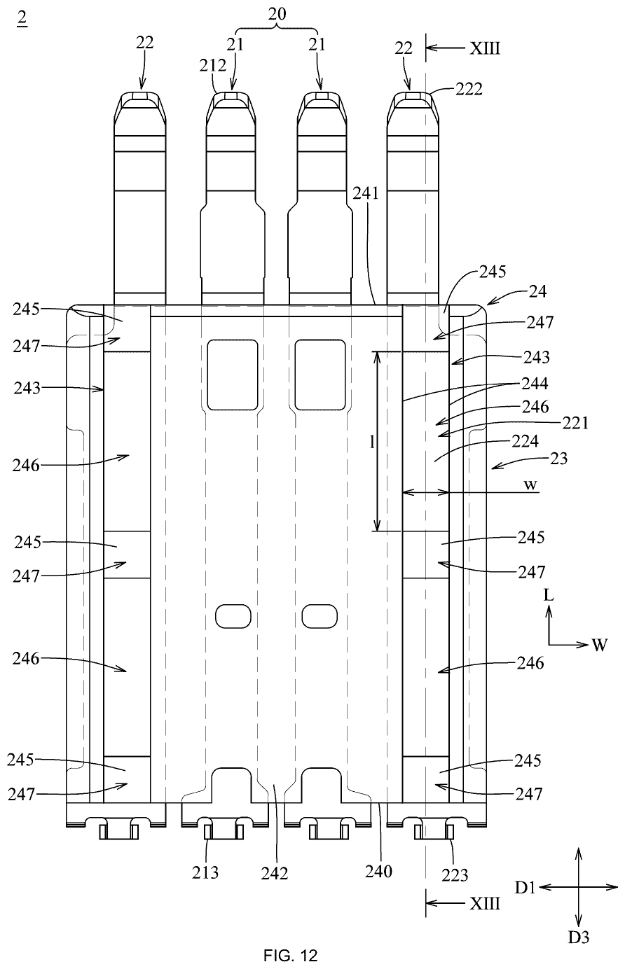

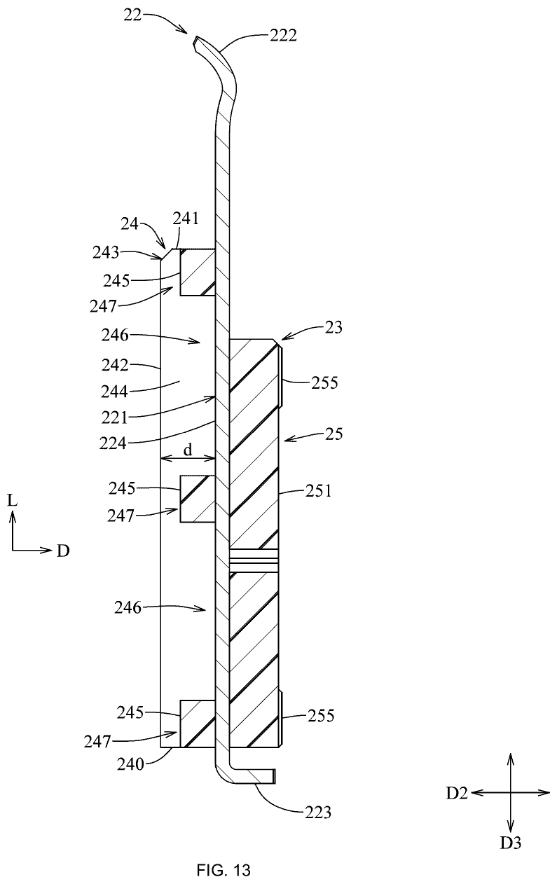

Referring to FIG. 11, FIG. 12 and FIG. 13, the surface 242 of the supporting bracket body 24 corresponds to the plate surfaces 224 of the two ground terminals 22. The surface 242 is provided with two depressed segments 243. At least a part of a position of each depressed segment 243 corresponds to the plate surface 224 of the corresponding ground terminal 22. Each depressed segment 243 is an elongated structure and a length direction of each depressed segment 243 extends along a length direction L of the corresponding ground terminal 22. The length direction L is parallel to the third direction D3. Because a dielectric constant of air is less than a dielectric constant of the insulative bracket 23, by a manner that the surface 242 of the supporting bracket body 24 is depressed to form the two depressed segments 243, the air is capable of being received in the two depressed segments 243 to lower the dielectric constant of the insulative bracket 23 at the two depressed segments 243. As such, coupling between each ground terminal 22 and the adjacent corresponding signal terminal 21 can be lowered, coupling between the two signal terminals 21 of the differential signal terminal pair 20 can be promoted, so that good signal integrity efficacy can be maintained when a signal is transmitted by the two signal terminals 21.

In the first embodiment, a position that each depressed segment 243 is perpendicularly projected onto the surface 242 of the supporting bracket body 24 and a position that the plate surface 224 of the corresponding ground terminal 22 is perpendicularly projected onto the surface 242 of the supporting bracket body 24 at least partially overlap with each other. Certainly, in the first embodiment, the position that each depressed segment 243 is perpendicularly projected onto the surface 242 of the supporting bracket body 24 and the position that the plate surface 224 of the corresponding ground terminal 22 is perpendicularly projected onto the surface 242 of the supporting bracket body 24 also may fully overlap with each other, which is not limited to the aforementioned partially overlap manner.

In the first embodiment, each depressed segment 243 at least extends to one of the bottom surface 240 and the top surface 241 of the supporting bracket body 24, as such, a length of the depressed segment 243 extending in the length direction L and an overlap area between the depressed segment 243 and the corresponding ground terminal 22 can be increased. Preferably, in the first embodiment, each depressed segment 243 extends to the bottom surface 240 and the top surface 241, so that the length of the depressed segment 243 in the length direction L is the same as a length of the supporting bracket body 24 taken along in the length direction L. As such, the length of the depressed segment 243 can be maximized, and the overlap area between the depressed segment 243 and the corresponding ground terminal 22 can be maximized.

In the first embodiment, each depressed segment 243 has two inner side surfaces 244 and a plurality of bridging portions 245. The two inner side surfaces 244 are spaced apart from each other along the first direction D1. The plurality of bridging portions 245 are connected between the two inner side surfaces 244 and are arranged to be spaced apart from each other along the length direction L. Each depressed segment 243 is formed with a plurality of first depressed holes 246. Each first depressed hole 246 is positioned between the two inner side surfaces 244 and is positioned between the adjacent two bridging portions 245. By a design manner that the plastic is cured to form the plurality of bridging portions 245 which are connected between the two inner side surfaces 244, flow uniformity in a process of the insulative bracket 23 which is molded by a plastic with insert molding can be increased, and a structure strength of the insulative bracket 23 after molded can be increased.

Each first depressed hole 246 is in form of elongated hole and a length direction of each first depressed hole 246 extends along the length direction L. Each first depressed hole 246 has a length I taken along the length direction L, a width w taken along a width direction W of the corresponding ground terminal 22, and a depth d taken along a depth direction D perpendicular to the length direction L and the width direction W. The width direction W and the depth direction D are respectively parallel to the first direction D1 and the second direction D2. Preferably, the larger the length 1, the width w and the depth d of the first depressed hole 246 in design are, the better is, as such, the first depressed hole 246 can receive more air and the overlap area between the depressed segment 243 and the corresponding ground terminal 22 is capable of being larger. Specifically, in the first embodiment, each first depressed hole 246 is a through hole in which the depth d extends to the plate surface 224 of the body portion 221 of the corresponding ground terminal 22 and which allows the plate surface 224 of the body portion 221 of the corresponding ground terminal 22 to be locally exposed. As such, a volume of the first depressed hole 246 receiving air can be maximized.

Furthermore, each bridging portion 245 is spaced apart from the surface 242 of the supporting bracket body 24. Each depressed segment 243 is further formed with a plurality of second depressed holes 247. Each second depressed hole 247 is positioned between the two inner side surfaces 244 and the corresponding bridging portion 245. Each second depressed hole 247 is a blind hole which is communicated with the corresponding first depressed hole 246 and does not allow the plate surface 224 of the body portion 221 of the corresponding ground terminal 22 to be exposed. By that the plurality of second depressed holes 247 can allow air to be receive therein, a volume of each depressed segment 243 which receives air can be further increased. Moreover, two of the plurality of second depressed holes 247 of each depressed segment 243 which are the most away from each other extend to the bottom surface 240 and the top surface 241 of the supporting bracket body 24 respectively, as such, air can flow upwardly into the depressed segment 243 via the second depressed hole 247 which extends to the bottom surface 240, or air can flow downwardly into the depressed segment 243 via the second depressed hole 247 which extends to the top surface 241.

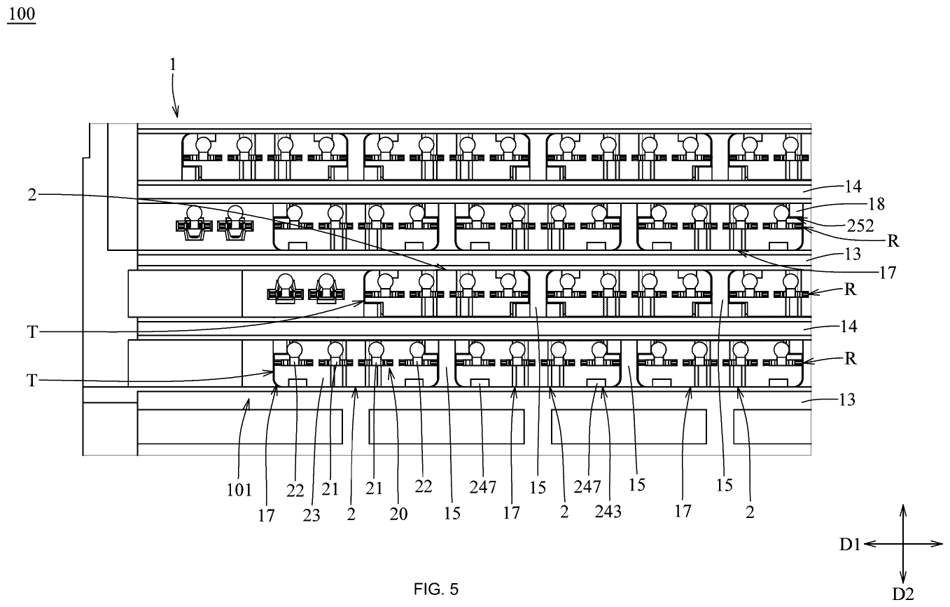

Referring to FIG. 4, FIG. 5, FIG. 7, FIG. 8 and FIG. 10, the retaining bracket body 25 of the insulative bracket 23 has an end surface 251 which is opposite to the surface 242 and faces the second side wall 14 provided with the first retaining portion 18, and at least one second retaining portion 252 which is provided to the end surface 251 and is used to be retained to the first retaining portion 18. In the first embodiment, the second side wall 14 corresponding to each receiving cavity 17 is provided with the two first retaining portions 18. The two first retaining portions 18 are spaced apart from each other along the first direction D1 and are respectively adjacent to the two corresponding partitioning plates 15. That the two first retaining portions 18 are respectively connected to the two corresponding partitioning plates 15 is taken as example, and the present disclosure is not limited thereto. The retaining bracket body 25 of the insulative bracket 23 has the two second retaining portions 252 which are used to respectively retain the two first retaining portions 18. The two second retaining portions 252 are respectively positioned to two opposite sides of the retaining bracket body 25. Each second retaining portion 252 corresponds to the corresponding ground terminal 22. By that the two second retaining portions 252 respectively retain the two first retaining portions 18, stability that the insulative bracket 23 is retained in the corresponding receiving cavity 17 can be increased.

Specifically, each first retaining portion 18 is a protruding rib which extends from the second side wall 14 toward an interior of the receiving cavity 17. Each second retaining portion 252 is a recessed groove which is recessed from the end surface 251 toward an interior of the retaining bracket body 25 and is used to allow the protruding rib to snap therewith.

More specifically, the retaining bracket body 25 of the insulative bracket 23 further has two outer side surfaces 253 which are spaced apart from each other along the first direction D1 and respectively face the two second retaining portions 252, two retaining protrusions 254 which respectively protrude from the two outer side surfaces 253, and a plurality of protruding portions 255 which protrude from the end surface 251. Each retaining protrusion 254 interferes with the corresponding first retaining portion 18, which can prevent the insulative bracket 23 from shaking relative to the insulative housing 1 along the first direction D1. The plurality of protruding portions 255 interfere with the corresponding second side wall 14, which can prevent the insulative bracket 23 from shaking relative to the insulative housing 1 along the second direction D2. As such, stability that the insulative bracket 23 is retained in the corresponding receiving cavity 17 can be increased.

Referring to FIG. 4 to FIG. 7, when each terminal module 2 is mounted to the corresponding receiving cavity 17 of the insulative housing 1, the elastic contact portion 212 of each signal terminal 21 and the elastic contact portion 222 of each ground terminal 22 each extend into between the corresponding partitioning ribs 131. The elastic contact portion 212 of each signal terminal 21 corresponds to the corresponding protruding block 132, which can lower impedance of the elastic contact portion 212. The two second retaining portions 252 of the insulative bracket 23 respectively retain the two first retaining portions 18. The two retaining protrusions 254 respectively interfere with the two corresponding first retaining portions 18. The plurality of protruding portions 255 interfere with the corresponding second side wall 14.

Referring to FIG. 8, FIG. 10, FIG. 11 and FIG. 12, by the design of the two depressed segments 243 of each terminal module 2, coupling between each ground terminal 22 and the adjacent corresponding signal terminal 21 can be lowered, so as to promote coupling between the two signal terminals 21 of the differential signal terminal pair 20, good signal integrity efficacy can be maintained when a signal is transmitted by the two signal terminals 21. As such, crosstalk between two adjacent differential signal terminal pairs 20 in each terminal row T or two adjacent terminal rows T can be lowered. Moreover, by that the two second retaining portions 252 constructed as the recessed grooves are respectively positioned to the two opposite sides of the retaining bracket body 25 and each second retaining portion 252 corresponds to the corresponding ground terminal 22, coupling between each ground terminal 22 and the adjacent corresponding signal terminal 21 can be further lowered, so as to further promote coupling between the two signal terminals 21 of the differential signal terminal pair 20, good signal integrity efficacy can be maintained when a signal is transmitted by the two signal terminals 21.

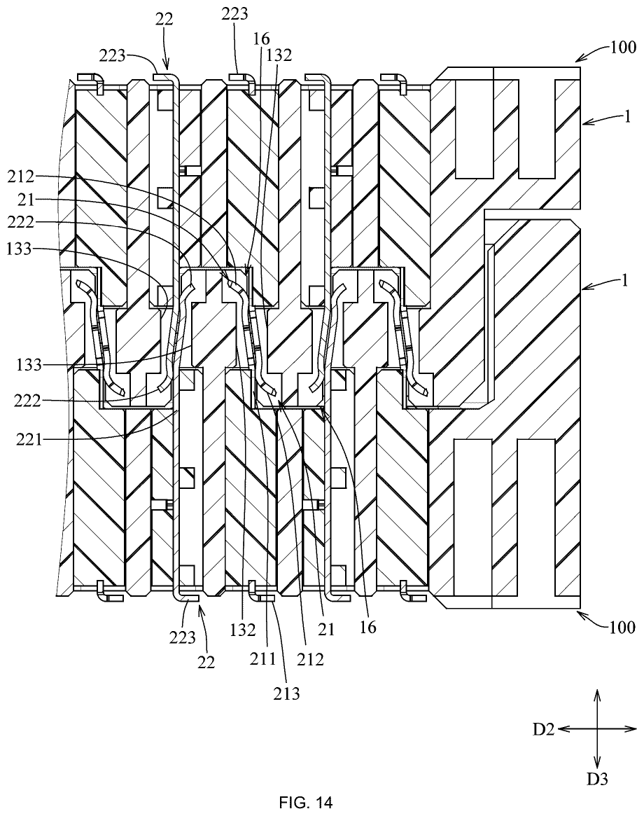

Referring to FIG. 6 and FIG. 14, when the two electrical connectors 100 mate with each other, the elastic contact portion 212 of each signal terminal 21 of each terminal module 2 mates with the body portion 211 of the signal terminal 21 of the corresponding terminal module 2, and the elastic contact portion 222 of each ground terminal 22 mates with the body portion 221 of the ground terminal 22 of the corresponding terminal module 2. Moreover, each protruding block 132 of the electrical connector 100 and the corresponding protruding block 132 of the other electrical connector 100 are spaced apart from each other in the second direction D2 and are positioned on two opposite sides of the two signal terminals 21which mate with each other, As such, impedances which are subjected by the signal in a transmission path between two contact points of the two signal terminals 21 mating with each other can be maintained similar or the same, so as to increase signal integrity efficacy.

Referring to FIG. 4, FIG. 5 and FIG. 14, in the two corresponding terminal rows T on two sides of each first side wall 13 of the insulative housing 1 of the electrical connector 100, the terminal modules 2 of the two terminal rows T are staggeringly provided on the two sides of the first side wall 13. Here, the elastic contact portions 222 of the ground terminals 22 and the elastic contact portions 212 of the signal terminals 21 in the two corresponding terminal modules 2 which are respectively provided to the two sides of the first side wall 13 are reversely provided and bend and extend respectively toward a direction close to the first side wall 13. The tail portions 223of the ground terminals 22 and the tail portions 213 of the signal terminals 21 in the two corresponding terminal modules 2 which are respectively provided to the two sides of the first side wall 13 all bend and extend toward the toward the same direction.

One of the terminal modules 2 which are provided to one side of the first side wall 13 corresponds to a position between the two corresponding adjacent terminal modules 2 which are provided to the other side of the first side wall 13, and each signal terminal 21 of one of the terminal modules 2 which are provided to one side of the first side wall 13 corresponds to a position of the corresponding ground terminal 22 of the corresponding terminal module 2 which is provided to the other side of the first side wall 13. As such, most of the differential signal terminal pairs 20 can be surrounded by the two ground terminals 22 in the same row and the corresponding ground terminals 22 in the adjacent row, so that crosstalk can be lowered.

In the two corresponding terminal rows T on two sides of each inserting groove 16 of the insulative housing 1 of the electrical connector 100, the terminal modules 2 in the two terminal rows T are staggeringly provided to the two sides of the inserting groove 16. Here, the elastic contact portions 222 of the ground terminals 22 and the elastic contact portions 212 of the signal terminals 21 in the two corresponding terminal modules 2 which are respectively provided to the two sides of the inserting groove 16 are reversely provided and respectively bend and extend toward a direction away from the inserting groove 16, are used to mate with the ground terminals 22 and the signal terminals 21 in the two corresponding terminal modules 2 which are respectively provided to the two sides of the first side wall 13 of the other electrical connector 100. The tail portions 223 of the ground terminals 22 and the tail portions 213 of the signal terminals 21 in the two corresponding terminal modules 2 which are respectively provided to the two sides of the inserting groove 16 bend and extend toward the same direction.

One of the terminal modules 2 which are provided to one side of the inserting groove 16 corresponds to a position between the two corresponding adjacent terminal modules 2 which are provided to the other side of the inserting groove 16, and each signal terminal 21 of one of the terminal modules 2 which are provided to one side of the inserting groove 16 corresponds to a position of the corresponding ground terminal 22 of the corresponding terminal module 2 which is provided to the other side of the inserting groove 16. As such, most of the differential signal terminal pairs 20 can be surrounded by the two ground terminals 22 in the same row and the two corresponding ground terminals 22 in the adjacent row, so that crosstalk can be lowered.

Referring to FIG. 11, FIG. 12 and FIG. 13, it is noted that, each depressed segment 243 of the first embodiment also may have the following different implementing manner as desired.

One implementing manner is that: the number of the bridging portion 245 and the number of the first depressed hole 246 each are one. The bridging portion 245 is flush with the surface 242 of the supporting bracket body 24 and is not spaced apart from the surface 242, so that each depressed segment 243 does not form the second depressed hole 247. The first depressed hole 246 is positioned to an end of the bridging portion 245.

Another implementing manner is that: the number of the bridging portion 245 is one, the number of the first depressed hole 246 is two. The bridging portion 245 is flush with the surface 242 of the supporting bracket body 24 and is not spaced apart from the surface 242, so that each depressed segment 243 does not form the second depressed hole 247. The two first depressed holes 246 are respectively positioned to two opposite ends of the bridging portion 245 and are arranged along the length direction L.

Still another implementing manner is that: the number of the bridging portion 245, the number of the first depressed hole 246 and the number of the second depressed hole 247 each are one. The first depressed hole 246 is positioned to an end of the bridging portion 245. The second depressed hole 247 is positioned to the bridging portion 245 and is communicated with the first depressed hole 246.

Yet another implementing manner is that: the number of the bridging portion 245 is one, the number of the first depressed hole 246 is two, the number of the second depressed hole 247 is one. The two first depressed holes 246 are respectively positioned to two opposite ends of the bridging portion 245 and are arranged along the length direction L. The second depressed hole 247 is positioned to the bridging portion 245 and is communicated with the two first depressed holes 246.

Further another implementing manner is that: each bridging portion 245 is flush with the surface 242 of the supporting bracket body 24 and is not spaced apart from the surface 242, so that each depressed segment 243 does not form the second depressed hole 247.

Referring to FIG. 10, FIG. 11, FIG. 12 and FIG. 13, in the first embodiment, the signal terminals 21 respectively are a first signal terminal and a second signal terminal which are fixed to the insulative bracket 23. The elastic contact portion 212 of each signal terminal 21 extends from a first end of the body portion 211. The tail portion 213 of each signal terminal 21 extends from a second end of the body portion 211. The second end is opposite to the first end. The surface 242 of the insulative bracket 23 covers at least most of the body portion 211 of the first signal terminal and at least most of the body portion 211 of the second signal terminal.

The ground terminals 22 respectively are a first ground terminal and a second ground terminal which are fixed to the insulative bracket 23. The first ground terminal is adjacent to the first signal terminal, the second ground terminal is adjacent to the second signal terminal. The elastic contact portion 222 of each ground terminal 22 extends from a first end of the body portion 221. The tail portion 223 of each ground terminal 22 extends from a second end of the body portion 221. The second end is opposite to the first end. The surface 242 of the insulative bracket 23 covers at least a part of the body portion 221 of the first ground terminal and at least a part of the body portion 221 of the second ground terminal. The surface 242 is provided with at least one first depressed segment and at least one second depressed segment. The first depressed segment exposes a part of the body portion 221 of the first ground terminal. The second depressed segment exposes a part of the body portion 221 of the second ground terminal. The first depressed segment is the first depressed hole 246 of one of the depressed segments 243, the second depressed segment is the first depressed hole 246 of the other of the depressed segments 243. Furthermore, the first depressed segment exposes most of the body portion 221 of the first ground terminal. The second depressed segment exposes most of the body portion 221 of the second ground terminal, a function of the depressed segment is to extend one region segment along the body portion 221, as such function thereof is attained.

In one implementing manner, the surface 242 is further provided with at least one third depressed segment which is positioned to a side of the first depressed segment, and at least one fourth depressed segment which is positioned to a side of the second depressed segment. A depressed depth of the third depressed segment is less than a depressed depth of the first depressed segment, a depressed depth of the fourth depressed segment is less than a depressed depth of the second depressed segment. The third depressed segment is the second depressed hole 247 of one of the depressed segments 243, the fourth depressed segment is the second depressed hole 247 of the other of the depressed segments 243. Furthermore, the surface 242 is provided the two third depressed segments which are respectively positioned to two opposite sides of the first depressed segment, and two fourth depressed segments which are respectively positioned to two opposite sides of the second depressed segment. The two third depressed segments respectively are the two second depressed holes 247 of one of the depressed segments 243, the two fourth depressed segments respectively are the two second depressed holes 247 of the other of the depressed segments 243.

In another implementing manner, the surface 242 is provided with two first depressed segments and two second depressed segments. The two first depressed segments respectively are the two first depressed holes 246 of one of the depressed segments 243, the two second depressed segments respectively are the two first depressed holes 246 of the other of the depressed segments 243. Furthermore, the surface 242 is further provided with at least one third depressed segment which is positioned to a side of the corresponding first depressed segment, and at least one fourth depressed segment which is positioned to a side of the corresponding second depressed segment, a depressed depth of the third depressed segment is less than a depressed depth of the first depressed segment, a depressed depth of the fourth depressed segment is less than a depressed depth of the second depressed segment. The third depressed segment is the second depressed hole 247 of one of the depressed segments 243, the fourth depressed segment is the second depressed hole 247 of the other of the depressed segments 243. Furthermore, the third depressed segment is positioned between the two first depressed segments, the fourth depressed segment is positioned between the two second depressed segments. More specifically, the surface 242 is provided with the two third depressed segments which are respectively positioned to two opposite sides of each first depressed segment, and two fourth depressed segments which are respectively positioned to two opposite sides of each second depressed segment. The two third depressed segments respectively are the two second depressed holes 247 of one of the depressed segments 243, the two fourth depressed segments are the two second depressed holes 247 of the other of the depressed segments 243.

In the two aforementioned implementing manners, the first depressed segment and the third depressed segment are arranged along a length direction L of the first ground terminal, the second depressed segment and the fourth depressed segment are arranged along a length direction L of the second ground terminal. The third depressed segment does not allow the body portion 221 of the first ground terminal to be exposed, the fourth depressed segment does not allow the body portion 221 of the second ground terminal to be exposed.

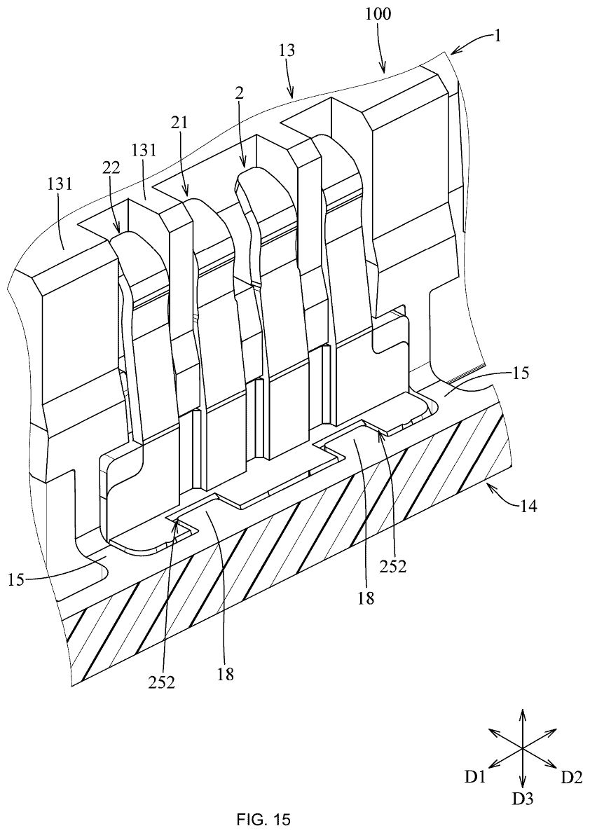

Referring to FIG. 15, a second embodiment of the electrical connector assembly of the present disclosure is substantially the same as the first embodiment in entire structure, difference lies in detailed structure of each electrical connector 100.

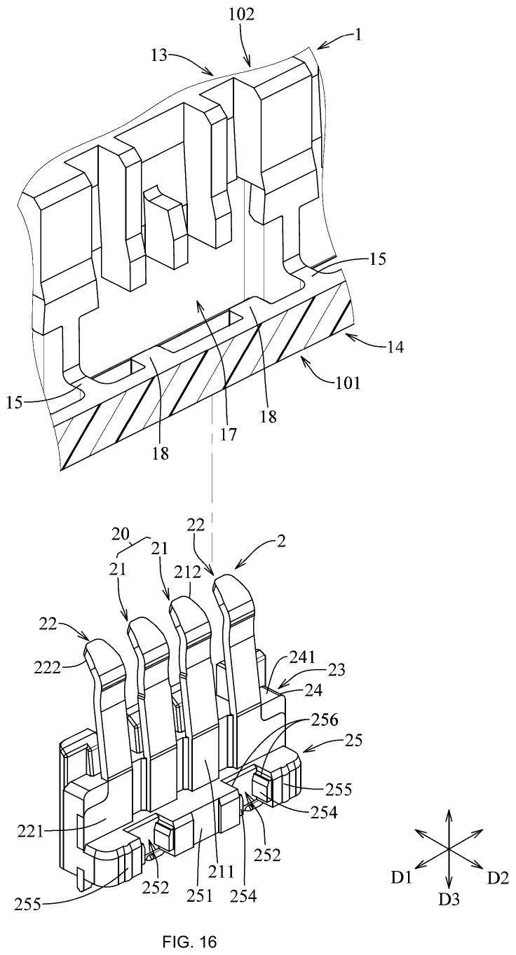

Referring to FIG. 15 and FIG. 16, in the second embodiment, the second side wall 14 corresponding to each receiving cavity 17 is provided with two first retaining portions 18 which are respectively spaced apart from the two corresponding partitioning plates 15. Each second retaining portion 252 of the insulative bracket 23 of the retaining bracket body 25 is correspondingly positioned between the corresponding signal terminal 21 and the corresponding ground terminal 22. Each second retaining portion 252 is retained to the corresponding first retaining portion 18. The retaining bracket body 25 of the insulative bracket 23 has two inner side surfaces 256 which are positioned to two opposite sides of the corresponding second retaining portion 252, and the retaining protrusion 254 which protrudes from at least one of the two inner side surfaces 256. The retaining protrusion 254 interferes with the corresponding first retaining portion 18. Specifically, the retaining bracket body 25 has the two retaining protrusions 254 which respectively protrude from the two inner side surfaces 256, the two retaining protrusions 254 interfere with the corresponding first retaining portion 18.

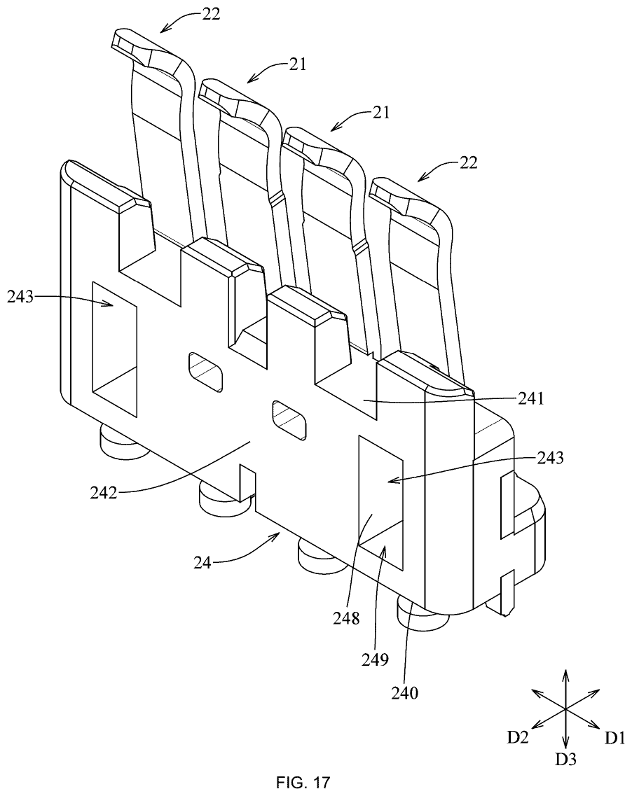

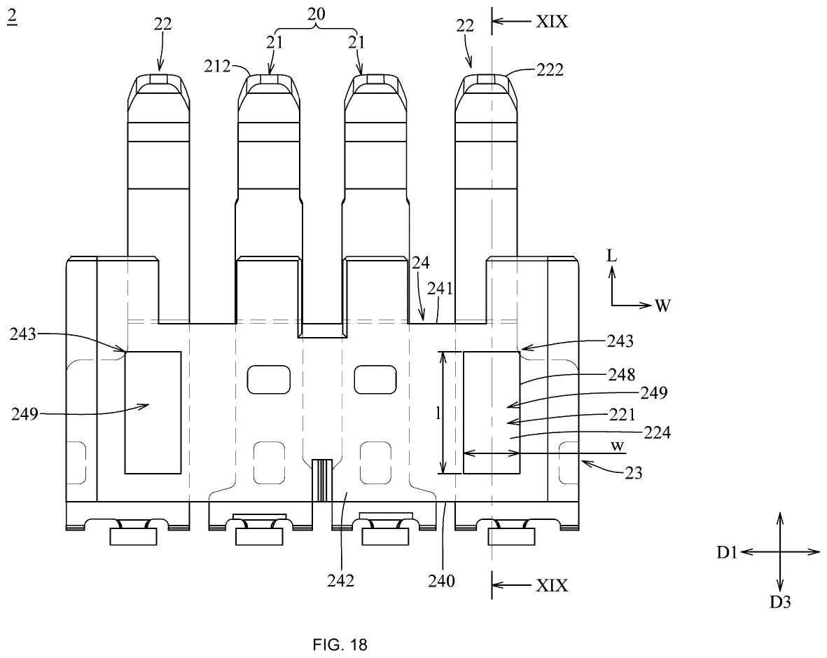

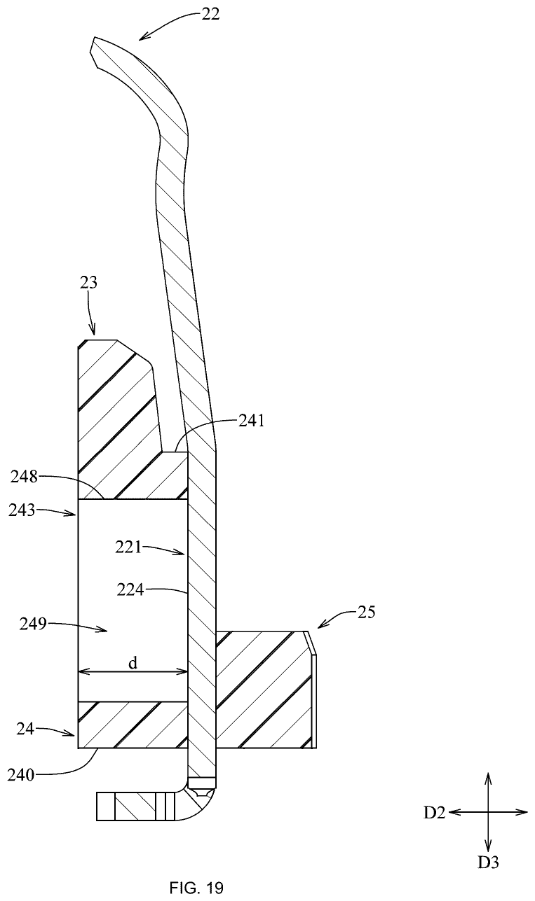

Referring to FIG. 17, FIG. 18 and FIG. 19, in the second embodiment, a position that each depressed segment 243 is perpendicularly projected onto the surface 242 of the supporting bracket body 24 and a position that the plate surface 224 of the corresponding ground terminal 22 is perpendicularly projected onto the surface 242 of the supporting bracket body 24 fully overlap with each other. Each depressed segment 243 is spaced apart from the bottom surface 240 and the top surface 241 of the supporting bracket body 24. Each depressed segment 243 has an inner periphery surface 248 which is in form of encircled and closed shape. Each depressed segment 243 is formed with a depressed hole 249 which is positioned within the inner periphery surface 248. The depressed hole 249 is a through hole in which the depth d extends to the plate surface 224 of the body portion 221 of the corresponding ground terminal 22 and which is defined by the inner periphery surface 248 and allows the plate surface 224 of the body portion 221 of the corresponding ground terminal 22 to be locally exposed.

It is noted that, each depressed segment 243 of the second embodiment also may have the following different implementing manners as desired.

One implementing manner is that: the position that each depressed segment 243 is perpendicularly projected onto the surface 242 of the supporting bracket body 24 and the position that the plate surface 224 of the corresponding ground terminal 22 is perpendicularly projected onto the surface 242 of the supporting bracket body 24 at least partially overlap with each other.

Another implementing manner is that: each depressed segment 243 of the depressed hole 249 is a blind hole in which the depth does not extend to the plate surface 224 of the corresponding ground terminal 22 and which does not allow the plate surface 224 of the corresponding ground terminal 22 to be exposed.

In conclusion, in the electrical connector 100 of each embodiment, by the design manner that each terminal module 2 has the two depressed segments 243 which are depressed to the surface 242, at least a part of a position of each depressed segment 243 corresponds to the corresponding ground terminal 22, and each depressed segment 243 is an elongated structure and a length direction of each depressed segment 243 extends along the length direction L of the corresponding ground terminal 22, coupling between each ground terminal 22 and the adjacent corresponding signal terminal 21 can be lowered, so as to promote coupling between the two signal terminals 21 of the differential signal terminal pair 20, good signal integrity efficacy can be maintained when a signal is transmitted by the two signal terminals 21, so that crosstalk between the two adjacent differential signal terminal pairs 20 can be lowered, thus the object of the present disclosure can be indeed attained.

However, the above description is only for the embodiments of the present disclosure, and it is not intended to limit the protective scope of the claims of the present disclosure, and the simple equivalent changes and modifications made according to the claims and the contents of the specification are still included in the scope of the claims of the present disclosure.

1. A terminal module, comprising:
a differential signal terminal pair;
two ground terminals which are respectively positioned to outer sides of the differential signal terminal pair, each ground terminal having a plate surface; and
an insulative bracket which is integrally molded to locally clad the differential signal terminal pair and the two ground terminals, the insulative bracket having a surface which corresponds to the plate surfaces of the two ground terminals, the surface being provided with two depressed segments, at least a part of a position of each depressed segment corresponding to the plate surface of the corresponding ground terminal, each depressed segment being an elongated structure and a length direction of each depressed segment extending along a length direction of the corresponding ground terminal.

2. The terminal module of claim 1, wherein
the insulative bracket further has a bottom surface which is connected to the surface and a top surface which is connected to the surface and is opposite to the bottom surface, each depressed segment at least extends to one of the bottom surface and the top surface.

3. The terminal module of claim 2, wherein
each depressed segment extends to the bottom surface and the top surface.

4. The terminal module of claim 1, wherein
the insulative bracket further has a bottom surface which is connected to the surface and a top surface which is connected to the surface and is opposite to the bottom surface, each depressed segment is spaced apart from the bottom surface and the top surface.

5. The terminal module of claim 1, wherein
each depressed segment is formed with a depressed hole.

6. The terminal module of claim 5, wherein
the depressed hole is a through hole which allows the plate surface of the corresponding ground terminal to be locally exposed.

7. The terminal module of claim 5, wherein
the depressed hole is a blind hole which does not allow the plate surface of the corresponding ground terminal to exposed.

8. The terminal module of claim 5, wherein
the depressed hole has an elongated hole shape and a length direction of the depressed hole extends along the length direction of the corresponding ground terminal, the depressed hole has a length taken along the length direction of the corresponding ground terminal, a width taken along a width direction of the corresponding ground terminal, and a depth taken along a depth direction which is perpendicular to the length direction and the width direction.

9. The terminal module of claim 1, wherein
each depressed segment is formed with a first depressed hole and a second depressed hole which are arranged along the length direction of the corresponding ground terminal and are communicated with each other,
the first depressed hole is a through hole which allows the plate surface of the corresponding ground terminal to be locally exposed,
the second depressed hole is a blind hole which does not allow the plate surface of the corresponding ground terminal to exposed.

10. The terminal module of claim 1, wherein
each depressed segment has two inner side surfaces and at least one bridging portion which is connected between the two inner side surfaces,
each depressed segment is formed with at least one first depressed hole which is positioned between the two inner side surfaces and is positioned to an end of the bridging portion.

11. The terminal module of claim 10, wherein
each depressed segment is formed with the two first depressed holes which are respectively positioned to two opposite ends of the bridging portion and are arranged along the length direction of the corresponding ground terminal.

12. The terminal module of claim 10, wherein
the bridging portion and the surface are spaced apart from each other each other,
each depressed segment is further formed with a second depressed hole which is positioned between the two inner side surfaces and the bridging portion,
the first depressed hole is a through hole which allows the plate surface of the corresponding ground terminal to be locally exposed,
the second depressed hole is a blind hole which is communicated with the first depressed hole and does not allow the plate surface of the corresponding ground terminal to be exposed.

13. The terminal module of claim 10, wherein
each depressed segment has a plurality of bridging portions which are arranged to be spaced apart from each other along the length direction of the corresponding ground terminal,
each depressed segment is formed with a plurality of first depressed holes, each first depressed hole is positioned between the two adjacent bridging portions.

14. The terminal module of claim 13, wherein
each bridging portion and the surface are spaced apart from each other,
each depressed segment is further formed with a plurality of second depressed holes,
each first depressed hole is a through hole which allows the plate surface of the corresponding ground terminal to be locally exposed,
each second depressed hole is positioned between the two inner side surfaces and the corresponding bridging portion, each second depressed hole is a blind hole which is communicated with the corresponding first depressed hole and does not allow the plate surface of the corresponding ground terminal to be exposed.

15. The terminal module of claim 14, wherein
the insulative bracket further has a bottom surface which is connected to the surface and a top surface which is connected to the surface and is opposite to the bottom surface,
two of the plurality of second depressed holes of each depressed segment which are the most away from each other extend to the bottom surface and the top surface respectively.

16. The terminal module of claim 1, wherein
each depressed segment has an inner periphery surface which is in form of encircled and closed shape,
each depressed segment is formed with a depressed hole which is positioned in the inner periphery surface.

17. The terminal module of claim 16, wherein
the depressed hole is a through hole which allows the plate surface of the corresponding ground terminal to be locally exposed.

18-30. (canceled)

31. A terminal module, comprising:
an insulative bracket having a surface;
a differential signal terminal pair fixed to the insulative bracket, the differential signal terminal pair having a first signal terminal and a second signal terminal, each signal terminal having a body portion, an elastic contact portion which extends from a first end of the body portion, and a tail portion which extends from a second end of the body portion, the surface covering at least most of the body portion of the first signal terminal and at least most of the body portion of the second signal terminal; and
a first ground terminal and a second ground terminal fixed to the insulative bracket, the first ground terminal being adjacent to the first signal terminal, the second ground terminal being adjacent to the second signal terminal, each ground terminal having a body portion, an elastic contact portion which extends from a first end of the body portion, and a tail portion which extends from a second end of the body portion, the surface covering at least a part of the body portion of the first ground terminal and at least a part of the body portion of the second ground terminal, the surface being provided with at least one first depressed segment, the first depressed segment exposing a part of the body portion of the first ground terminal, the surface being provided with at least one second depressed segment, the second depressed segment exposing a part of the body portion of the second ground terminal.

32. The terminal module of claim 31, wherein
the first depressed segment exposes most of the body portion of the first ground terminal,
the second depressed segment exposes most of the body portion of the second ground terminal.

33. The terminal module of claim 31, wherein
the surface further provided with at least one third depressed segment which is positioned to a side of the first depressed segment and at least one fourth depressed segment which is positioned to a side of the second depressed segment,
a depressed depth of the third depressed segment is less than a depressed depth of the first depressed segment,
a depressed depth of the fourth depressed segment is less than a depressed depth of the second depressed segment.

34-38. (canceled)
